(19) United States
(12) Patent Application Publication
(10) Pub. No.: US 2013/0288508 A1
(43) Pub. Date: Oct. 31, 2013

(54) CONNECTOR

(71) Applicants: Takashi Sekine, Kanagawa (JP); Kenichi Yamaguchi, Kanagawa (JP)

(72) Inventors: Takashi Sekine, Kanagawa (JP); Kenichi Yamaguchi, Kanagawa (JP)

(21) Appl. No.: 13/978,900

(22) PCT Filed: Jan. 11, 2012
(86) PCT No.: PCT/JP2012/050339

§ 371 Date: Jul. 10, 2013

(30) Foreign Application Priority Data
Jan. 12, 2011 (JP) 2011-004053
Jul. 15, 2011 (JP) 2011-156439

(51) Int. Cl. H01R 13/629

(52) U.S. Cl. CPC H01R 13/629
USPC 439/345

(57) ABSTRACT

To provide a connector with which a terminal can be easily connected to a substrate without soldering. A connector (10) is configured such that a contact portion (13b) formed at a terminal (13) so as to be elastically deformable in the vertical direction is brought into contact with the upper surface of an LED substrate (3) and is thereby made conductive with the LED substrate (3), and such that a locking portion (14c) of each of locking members (14) is locked to the lower surface of a mounting substrate (4), and thereby the contact portion (13b) of the terminal (13) is held in a state of being in press-contact with the upper surface of the LED substrate (3). Thereby, the terminal (13) can be easily connected to the LED substrate (3) without soldering, and hence the mounting work of the connector (10) can be performed very easily.

### TECHNICAL FIELD

The present invention relates to a connector which is mounted, for example, to a substrate of a light-bulb type lamp using an LED and which is used for connecting the substrate to a power supply cable.

### BACKGROUND ART

Generally, as a light-bulb type lamp using an LED, there is known a type which is configured by a main body portion attached to a lighting apparatus, a substrate with an LED mounted thereto, and a spherical cover covering the substrate, and which is configured to irradiate the light of the LED on the substrate to the outside through the cover (see, for example, Patent Literature 1). Similarly to a conventional light bulb, this light-bulb type lamp is configured such that a base which is screwed to a socket of the lighting apparatus is provided at the main body portion, and such that external electric power is supplied to the LED via a wiring connecting the base to the substrate. In this case, a connector, which connects the wiring cable to the conductive pattern of the substrate, is mounted to the substrate.

The connector used for this light-bulb type lamp includes a connector main body inserted into a mounting hole provided in the substrate, and a terminal held at the connector main body, and is configured such that one end side of the terminal is connected to the LED mounting surface of the substrate, and such that the other end side of the terminal is connected to the cable (see, for example, Patent Literature 2).

### CITATION LIST

### Patent Literature

Patent Literature 1: Japanese Patent Publication No. 2010-33959

Patent Literature 2: Japanese Design Registration No. 1385523

### SUMMARY OF INVENTION

### Technical Problem

However, the conventional connector is configured such that the connector main body is inserted into the mounting hole and then the one end side of the terminal is connected to the substrate by soldering. Therefore, the conventional connector has a problem that the soldering work of the terminal is required at the time of mounting the connector and hence the mounting work of the connector becomes complicated.

The present invention has been made in view of the above described problem. An object of the present invention is to provide a connector which can be connected to a substrate easily without soldering a terminal to the substrate.

### Solution to Problem

In order to achieve the above-described object, a connector according to the present invention includes a connector main body inserted into a mounting hole provided in a plate-like mounting object, and an a terminal held at the connector main body, the terminal being connected to one surface in a thickness direction of the mounting object, the connector including: a contact portion which is formed at the terminal so as to be elastically deformable in the thickness direction of the mounting object and which is made conductive with the mounting object by being brought into contact with the one surface in the thickness direction of the mounting object; and a locking member which is mounted to the connector main body and which is provided with a locking portion that is locked to the other surface in the thickness direction of the mounting object to thereby hold the contact portion of the terminal in a state where the contact portion is in press-contact with the one surface in the thickness direction of the mounting object, in which the locking member is formed so that a gap between the contact portion and the locking portion is smaller than a thickness dimension of the mounting object, the connector main body is held at the mounting object by the mounting object being sandwiched between the contact portion and the locking portion, and the connector main body is formed so as to be able to mount therein a plurality of kinds of locking members respectively having different gaps between the contact portion and the locking portion.

With such configuration, the contact portion formed at the terminal so as to be elastically deformable in the vertical direction is brought into contact with the one surface in the thickness direction of the mounting object, so that the contact portion and the mounting object are made conductive with each other. Also, the locking portion is locked to the other surface of the substrate in the thickness direction, so that the contact portion of the terminal is held in a state of being in press-contact with the one surface of the mounting object in the thickness direction. Thereby, the terminal can be connected to the mounting object without soldering. Further, the terminal can be attached to the other mounting object having a different thickness dimension by replacing the locking member with another kind of locking member having a different gap between the contact portion and the locking portion. The versatility of the connector can be improved.

### Advantageous Effects of Invention

According to the present invention, the terminal can be connected to the substrate without soldering, and hence the mounting work of the connector can be performed very easily. Further, the terminal can be attached to another mounting object having a different dimension, and hence the versatility of the connector can be improved.

### BRIEF DESCRIPTION OF DRAWINGS

FIG. 1 is an upper side perspective view of a connector showing a first embodiment according to the present invention.

FIG. 2 is a lower side perspective view of the connector.

FIG. 3 is a front view of the connector.

FIG. 4 is a rear view of the connector.

FIG. 5 is a plan view of the connector.

FIG. 6 is a bottom view of the connector.

FIG. 7 is a side view of the connector.

FIG. 8 is a sectional view along the line A-A in FIG. 5.

FIG. 9 is a sectional view along the line B-B in FIG. 5.

FIG. 10 is a sectional view along the line C-C in FIG. 5.

FIG. 11 is a perspective view of a terminal.

FIG. 12 is a front view of the terminal.

FIG. 13 is a front view of a main portion of the terminal.

FIG. 14 is a front view of a main portion of the terminal, showing a cable connection state.

FIG. 15 is an upper side exploded perspective view showing the connector.

FIG. 16 is a perspective view showing a part of an LED substrate and a mounting substrate.

FIG. 17 is a plan view showing a part of the LED substrate and the mounting substrate.

FIG. 18 is a side sectional view showing a mounting process of the connector.

FIG. 19 is a side sectional view showing a mounting process of the connector.

FIG. 20 is a side sectional view showing a mounting state of the connector.

FIG. 21 is a side sectional view showing the mounting state of the connector.

FIG. 22 is a perspective view showing a part of the LED substrate and the mounting substrate and showing the mounting state of the connector.

FIG. 23 is an exploded perspective view of a light-bulb type lamp.

FIG. 24 is a side sectional view of a connector showing a second embodiment according to the present invention.

FIG. 25 is a side sectional view showing a mounting process of the connector.

FIG. 26 is a side sectional view showing a mounting process of the connector.

FIG. 27 is a side sectional view showing a mounting state of the connector.

FIG. 28 is a side view of a locking member showing a displacement state of a locking portion.

### DESCRIPTION OF EMBODIMENTS

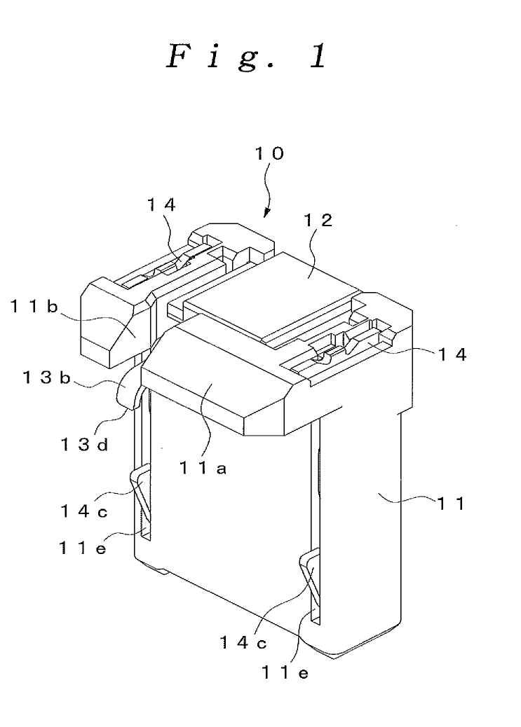

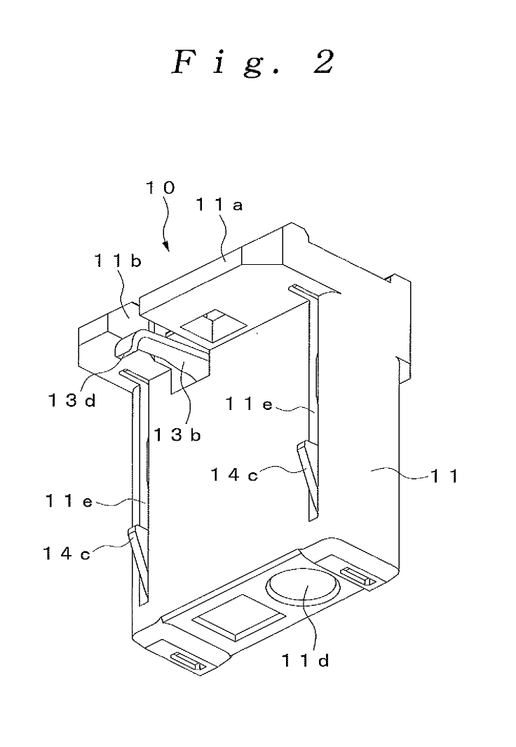

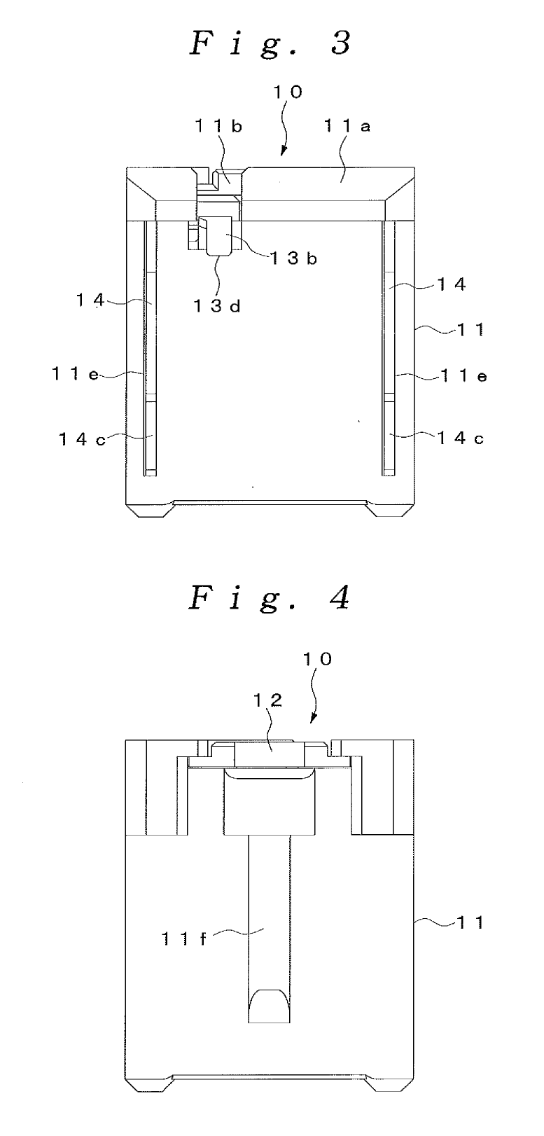

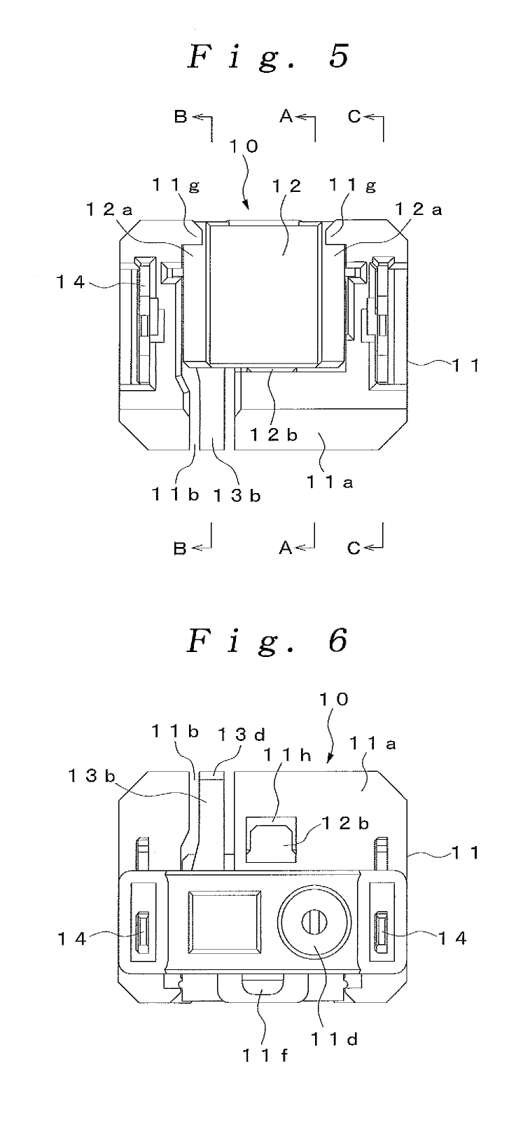

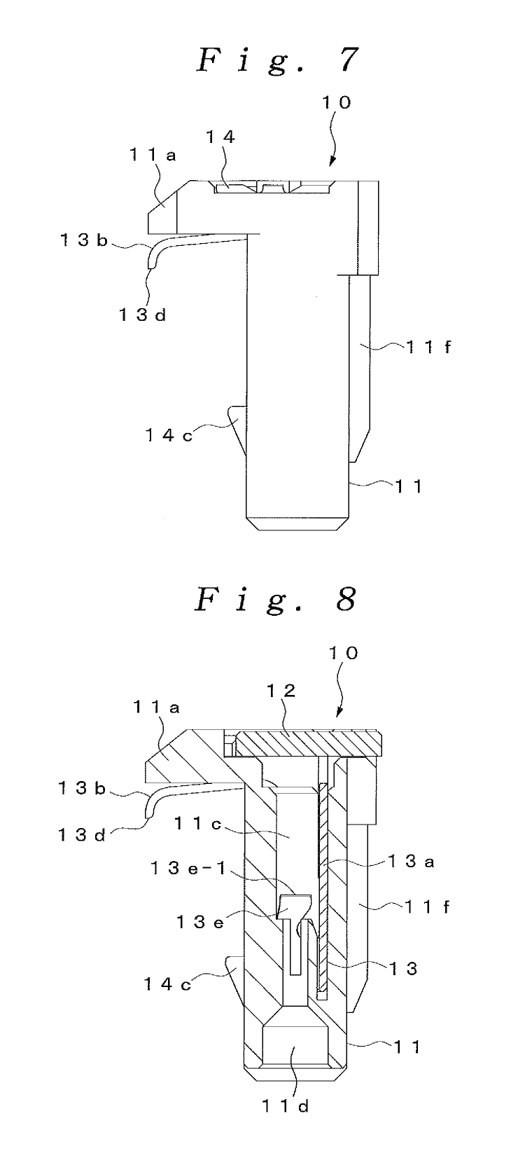

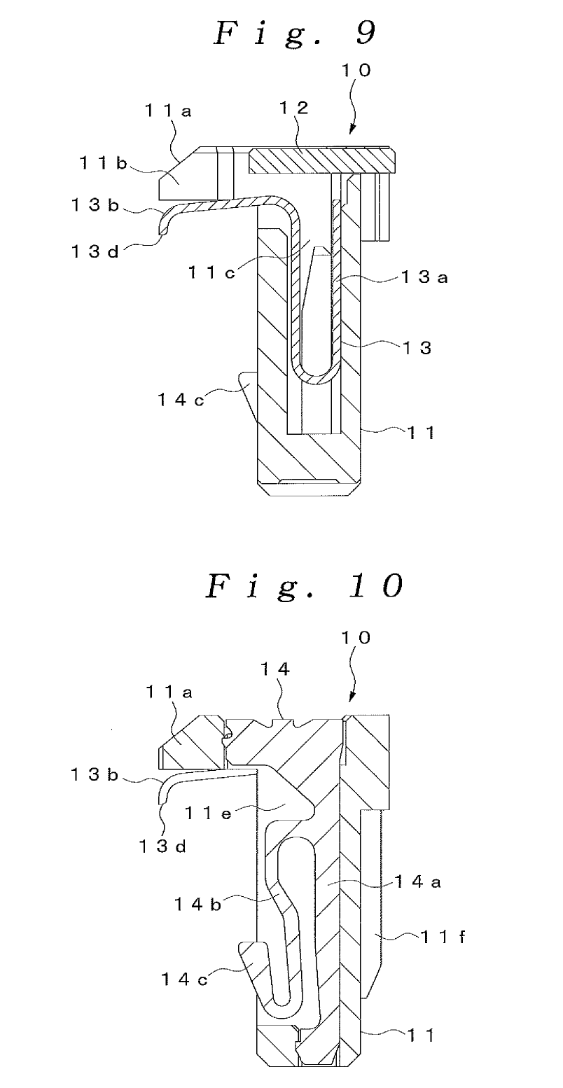

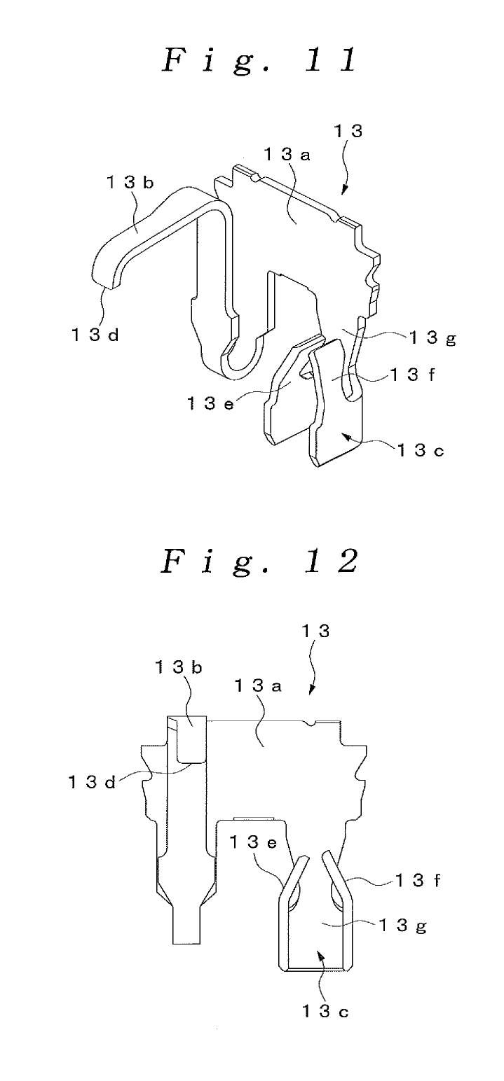

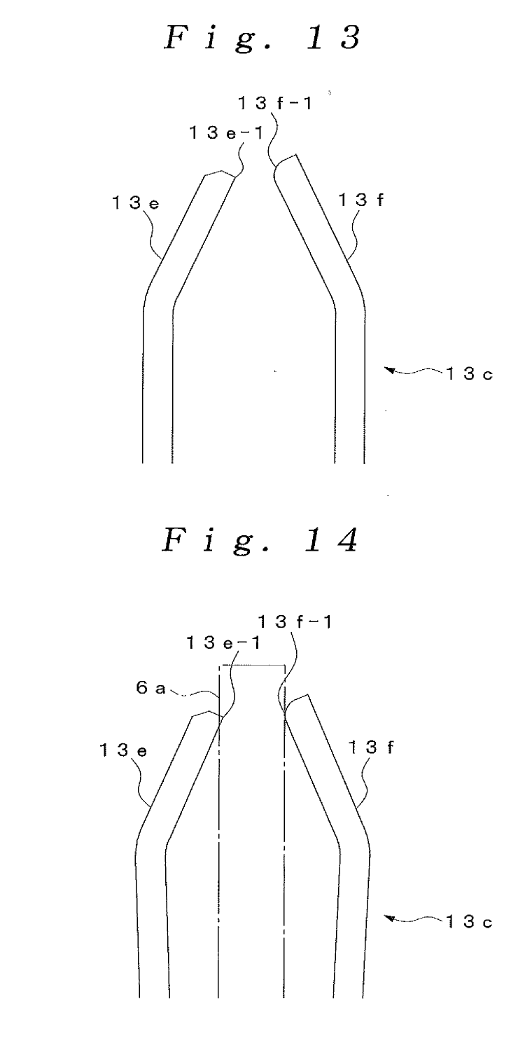

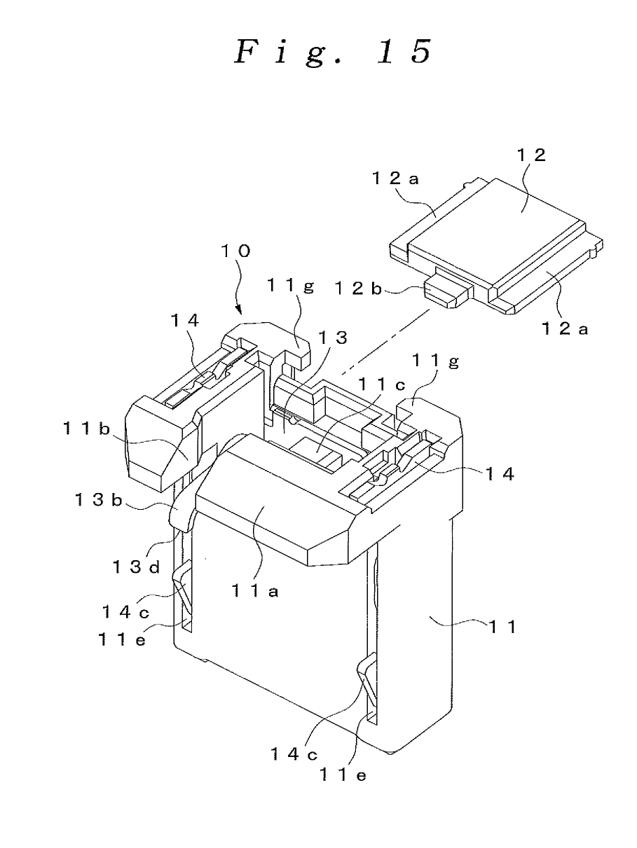

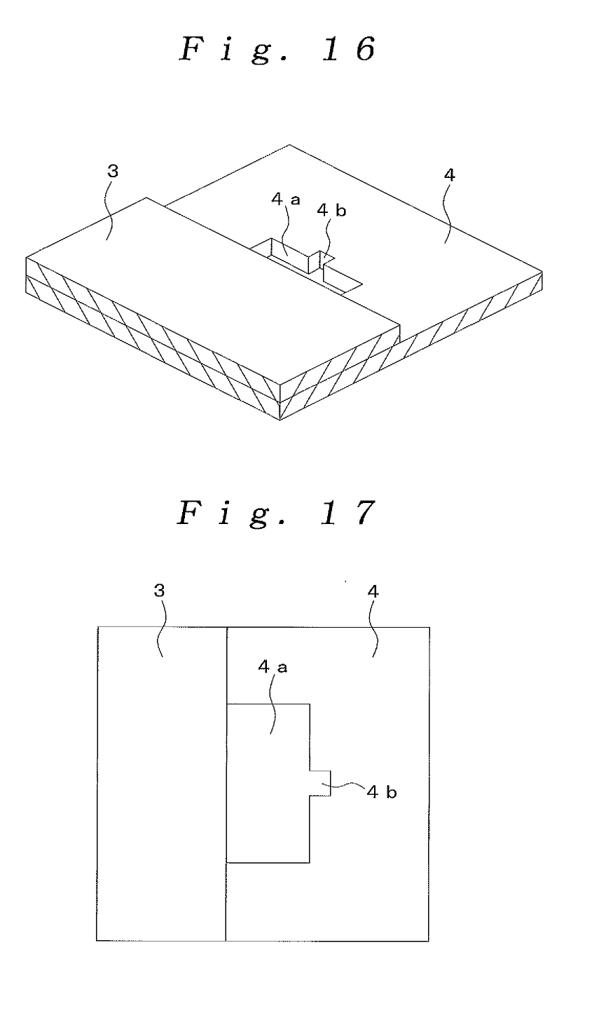

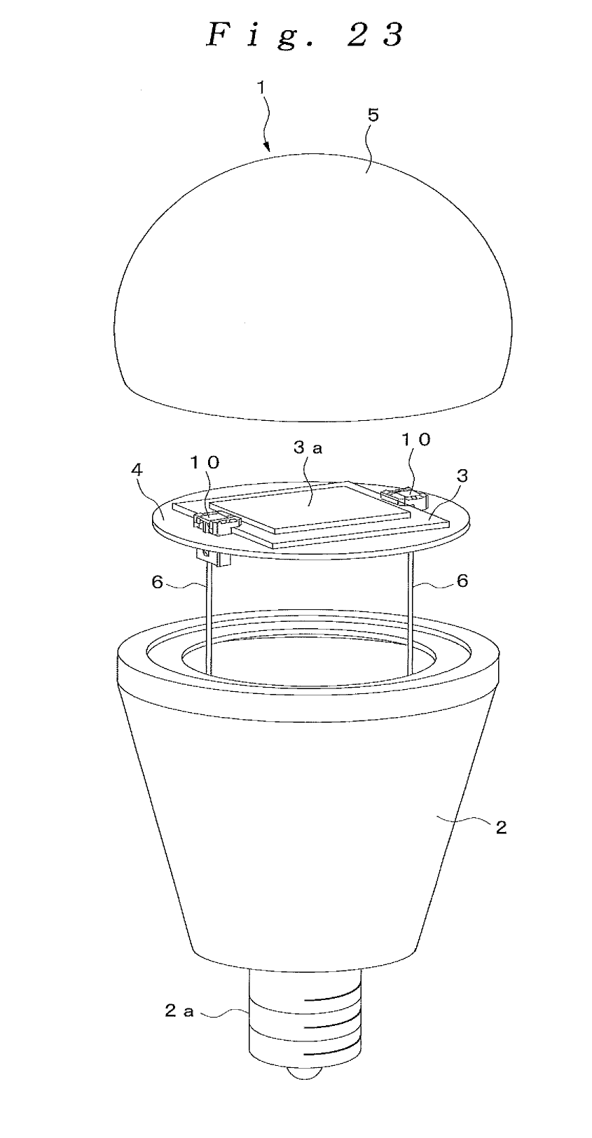

FIG. 1 to FIG. 23 show a first embodiment according to the present invention. A connector shown in the figures is mounted to a substrate of a light-bulb type lamp using an LED and is used for connecting a power supply cable as a connection object to the substrate.

A light-bulb type lamp 1 shown in the figures is configured by a main body portion 2 attached to a lighting apparatus, an LED substrate 3 with an LED mounted on the upper surface thereof, a mounting substrate 4 with the LED substrate 3 mounted on the upper surface thereof, and a spherical cover 5 covering the upper side of the LED substrate 3 and the mounting substrate 4, and is configured to irradiate the light of the LED to the outside through the cover 5. Note that the LED substrate 3 and the mounting substrate 4 form a plate-like mounting object.

The main body portion 2 is formed with a hollow case having an opening on the upper surface thereof. A base 2a, which is screwed to a socket (not shown) of the lighting apparatus, is provided at the lower end of the main body portion 2. The base 2a is connected to the LED substrate 3 via a cable 6 so that external electric power is supplied to the LED substrate 3 from the base 2a.

The LED substrate 3 is formed in a quadrangular shape, and is fixed to the upper surface of the mounting substrate 4 so as to overlap the upper surface of the mounting substrate 4. In this case, one LED 3a formed in a flat shape is mounted to the LED substrate 3. Note that, in FIG. 16, FIG. 17 and FIG. 22, only a part of the LED substrate 3 and of the mounting substrate 4 is illustrated.

The mounting substrate 4 is formed in a disc shape so as to be fixed to the upper surface of the main body portion 2. A connector 10, which connects the cable 6 to the LED substrate 3, is mounted to the mounting substrate 4, and the connector 10 is fitted into a mounting hole 4a provided in the mounting substrate 4. The mounting hole 4a is formed as a quadrangular through hole arranged at each of both end sides of the LED substrate 3, and one width-direction inner surface of the mounting hole 4a is located to form the same plane with the end surface of the LED substrate 3. Further, a recessed portion 4b engaging with a part of the connector 10 described below is provided at the other width-direction inner surface of the mounting hole 4a.

The connector 10 includes a connector main body 11 inserted into the mounting hole 4a of the mounting substrate 4, an upper surface cover 12 covering the upper surface of the connector main body 11, an electrical connection terminal 13 held at the connector main body 11, and a pair of locking members 14 locked to the connector main body 11, and is configured such that one end side of the terminal 13 is made conductive with the upper surface (one surface in the thickness direction) of the LED substrate 3, and such that the cable 6 is connected to the other end side of the terminal 13.

The connector main body 11 is formed by a synthetic resin molding, and is formed in an elongated rectangular parallelepiped shape in which the front-rear direction dimension is smaller than the width-direction dimension. An extension portion 11a extending frontward is provided on the upper surface side of the connector main body 11, and a notch lib, into which the one end side of the terminal 13 is inserted, is provided at a portion close to one width-direction end of the extension portion 11a. A terminal housing portion 11c, which houses the terminal 13 therein, is provided in the connector main body 11, and the upper surface of the terminal housing portion 11c is opened at the upper surface of the connector main body 11. A circular insertion port 11d, into which the cable 6 is inserted, is provided at a portion close to the other width-direction end of the lower surface of the connector main body 11, and the insertion port 11d is made to communicate with the inside of the terminal housing portion 11c. A holding hole 11e for holding each of the locking members 14 is provided at each of both width-direction sides of the inside of the connector main body 11. Each of the holding holes 11e is opened in the front surface of the connector main body 11 so as to extend in the vertical direction, and the opened portion is formed in the front surface of the connector main body 11 except the extension portion 11a so as to have a length substantially covering the entire vertical length of the front surface of the connector main body 11. A rib 11f extending in the vertical direction is projectingly provided on the rear surface of the connector main body 11, and the rib 11f is arranged at the width-direction center of the connector main body 11.

The upper surface cover 12 is formed into a quadrangular plate shape covering the upper surface opening portion of the terminal housing portion 11c, and is configured to be attached to the upper surface side of the connector main body 11 by being mounted to the connector main body 11 from the rear side of the connector main body 11. A flange portion 12a extending in the front and rear direction is provided at each of both width-direction sides of the upper surface cover 12. Each of the flange portions 12a is configured to engage, from below, with each of a pair of locking portions 11g which are arranged in the width direction of the terminal housing portion 11c and which are provided at the rear end side of the upper surface opening portion of the terminal housing portion 11c. A projecting portion 12b projecting frontward is provided at the front end of the upper surface cover 12. The projecting portion 12b is configured to engage with a hole 11h provided on the front end side of the upper surface opening portion of the terminal housing portion 11c.

The terminal 13 is formed by a bent conductive metal plate, and is housed in the terminal housing portion 11c of the connector main body 11 by being inserted into the terminal housing portion 11c from the upper surface opening portion of the terminal housing portion 11c. The terminal 13 is configured by a fixed piece portion 13a formed in a plate shape, a contact portion 13b extending from one width-direction end side of the fixed piece portion 13a, and a cable connecting portion 13c extending from the other width-direction end side of the fixed piece portion 13a.

The fixed piece portion 13a is configured to be fixed to the terminal housing portion 11c in such a manner that both the width-direction ends of the fixed piece portion 13a are brought into press-contact with the inner surfaces of the terminal housing portion 11c.

The contact portion 13b is formed so that it extends downward from the fixed piece portion 13a and is bent upward so as to further extend to the front side. The contact portion 13b is formed to be elastically deformable in the vertical direction (in the thickness direction of the LED substrate 3 and the mounting substrate 4), and a contact 13d which is brought into contact with the LED substrate 3 is provided at the distal end of the contact portion 13b so as to be bent downward.

The cable connecting portion 13c extends downward from the fixed piece portion 13a. Also, on both width-direction sides of the cable connecting portion 13c, a pair of first and second contact pieces 13e and 13f, between which a conducting wire 6a of the cable 6 is sandwiched, are provided so as to face each other. Each of the contact pieces 13e and 13f is formed in such a manner that both width-direction sides of an extension portion 13g (a predetermined portion of the terminal body) extending downward from the fixed piece portion 13a are bent frontward and raised so as to face each other, and that the distal end side of the raised portions extending upward are inclined so as to become closer to each other. In this case, the distal end side of each of the contact pieces 13e and 13f is formed to be elastically deformable in the width direction of the cable connecting portion 13c (in the direction in which the contact pieces 13e and 13f face each other). A first contact portion 13e-1, which is brought into biting contact with the conducting wire 6aof the cable 6, is provided at a distal end corner portion of the first contact piece 13e. The first contact portion 13e-1 is formed as a corner portion having a substantially right-angled cross section. A second contact portion 13f-1, which is slidably brought into surface contact with the conducting wire 6a of the cable 6, is provided at a distal end of the second contact piece 13f. The second contact portion 13f-1 is formed in such a manner that the distal end corner portion of the second contact piece 13f is chamfered to a curved surface shape. In this case, the contact portions 13f-1 and 13e-1 are arranged so as to face each other in the width direction of the cable connecting portion 13c (in the direction perpendicular to the insertion direction of the cable 6).

Each of the locking members 14 is made of a metal plate formed by punching and is mounted to the connector main body 11. The locking member 14 is configured by a fixed piece portion 14a extending from the upper end to the lower end of the inside of the holding hole 11e, an elastic piece portion 14b extending from the fixed piece portion 14a, and a locking portion 14c provided at the distal end of the elastic piece portion 14b. The locking portion 14c is configured to be locked to the lower surface (the other surface in the thickness direction) of the mounting substrate 4. The fixed piece portion 14a is configured to be fixed to the holding hole 11e in such manner that both front and rear ends of each of the upper and lower end sides of the fixed piece portion 14a are brought into press-contact with the inner surface of the holding hole 11e. The elastic piece portion 14b is formed to extend downward in front of the fixed piece portion 14a and to be further bent upward in front of the downward extending portion. The locking portion 14c is formed to project frontward from the distal end of the elastic piece portion 14b, and projects from the opening portion of the holding hole 11e to the front of the connector main body 11. In this case, the upper end of the locking portion 14c is formed horizontally, and the lower end side of the locking portion 14c is formed in a shape inclined rearward and downward.

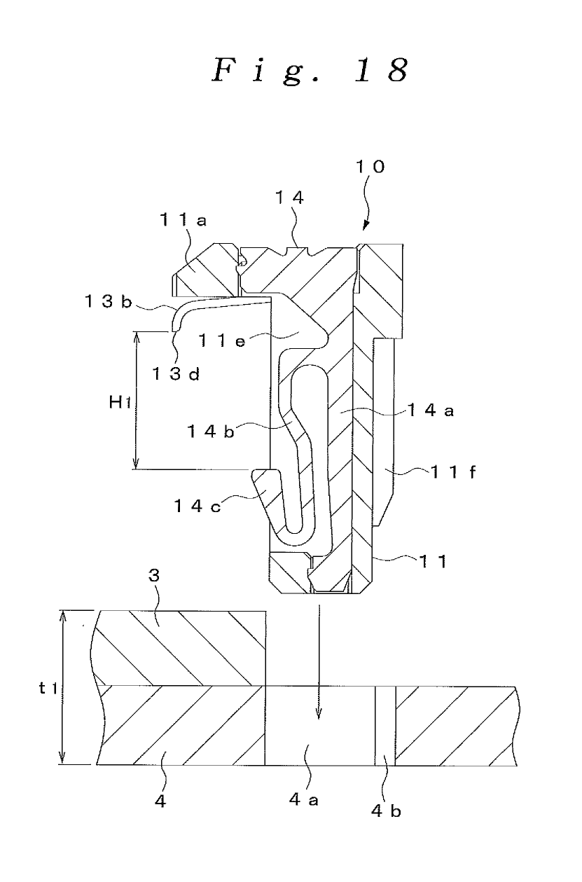

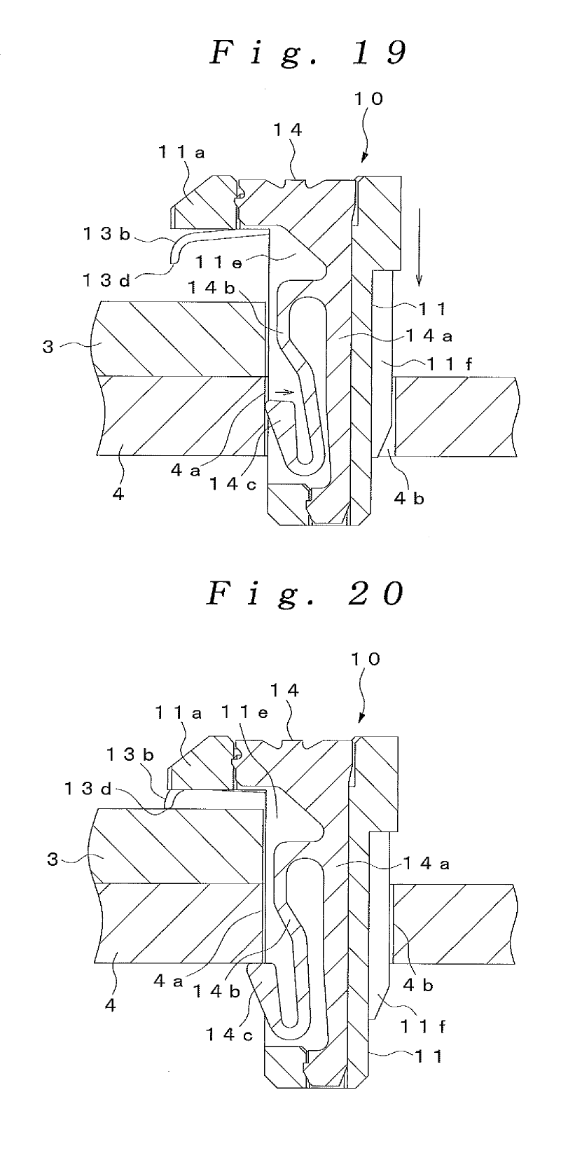

When the connector 10 configured as described above is attached to the LED substrate 3 and the mounting substrate 4, the connector main body 11 is inserted into the mounting hole 4a of the mounting substrate 4 from the upper side of the mounting hole 4a as shown in FIG. 18. At this time, the rib 11f of the connector main body 11 is made to engage with the recessed portion 4b of the mounting hole 4a. Further, when the connector main body 11 is inserted into the mounting hole 4a, and when the locking portion 14c of each of the locking members 14 is brought into contact with the upper edge of the LED substrate 3, the elastic piece portion 14b is elastically deformed rearward by the inclination of the lower end side of the locking portion 14c, so that the locking portion 14c is displaced rearward in the holding hole 11e while being in contact with the inner surface of the mounting hole 4a as shown in FIG. 19. Then, when the locking portion 14c goes over the inner surface of the mounting hole 4a, the elastic piece portion 14b is restored to its original shape to enable the locking portion 14c to be displaced frontward, and thereby the locking portion 14c is locked to the lower surface of the mounting substrate 4 as shown in FIG. 20. Further, when the connector main body 11 is inserted into the mounting hole 4a, the contact 13d of the contact portion 13b of the terminal 13 is brought into contact with the upper surface of the LED substrate 3, and also the contact portion 13b is elastically deformed upward, so that the contact 13d is brought into press-contact with the LED substrate 3 by the restoring force of the contact portion 13b. Thereby, the contact portion 13b is made conductive with the conductive pattern (not shown) of the LED substrate 3, so that the terminal 13 is connected to the LED substrate 3. At this time, a gap H1, which is formed before the elastic deformation and which extends vertically between the contact 13d of the contact portion 13b and the locking portion 14c, is made slightly smaller than the thickness t1 of the LED substrate 3 and the mounting substrate 4. Thereby, when the locking portion 14c is locked to the lower surface of the mounting substrate 4, the contact portion 13b of the terminal 13 is brought into press-contact with the upper surface of the LED substrate 3, so that the connector main body 11 in the mounting hole 4a is held in a state where the vertical movement of the connector main body 11 is regulated with respect to the LED substrate 3 and the mounting substrate 4. Further, the rib 11f of the connector main body 11 is engaged with the recessed portion 4b of the mounting hole 4a, and thereby the movement of the connector 10 in the width direction is regulated.

Next, the cable 6, the conducting wire 6aof which is exposed by removing the sheath at distal end portion of the cable 6, is inserted into the insertion port 11d of the connector main body 11, and thereby the cable 6 is connected to the terminal 13. At this time, the conducting wire 6aof the cable 6 is inserted between the respective contact pieces 13e and 13f of the cable connecting portion 13c as shown in FIG. 14, so that the gap between the contact pieces 13e and 13f is expanded while each of the contact pieces 13e and 13f is in contact with the conducting wire 6a. Thereby, each of the contact pieces 13e and 13f is brought into press-contact with the conducting wire 6a, so that the cable 6 is connected to the terminal 13. At this time, since the first contact portion 13e-1 of the first contact piece 13e is brought into biting contact with the conducting wire 6a, the movement of the conducting wire 6ain the direction opposite to the insertion direction is regulated, so that the conducting wire 6ais prevented from coming off from the cable connecting portion 13c. Further, the second contact portion 13f-1 of the second contact piece 13f is slidably brought into surface contact with the conducting wire 6awithout biting into the conducting wire 6a, and hence the contact area between the second contact piece 13f and the conducting wire 6ais sufficiently secured. In this case, the first and second contact portions 13e-1 and 13f-1 are arranged so as to face each other in the direction perpendicular to the insertion direction of the conducting wire 6a, and hence the pressing force from each of the contact portions 13e-1 and 13f-1 is applied at the same position in the axis direction of the conducting wire 6a.

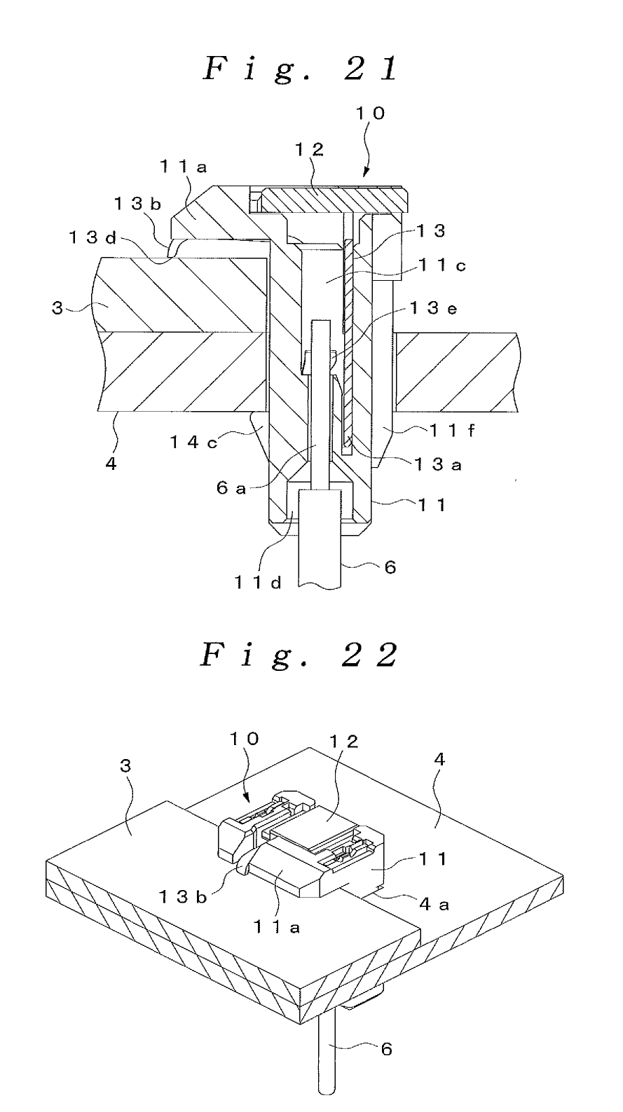

A pair of the connectors 10 are mounted to the LED substrate 3 and the mounting substrate 4 as shown in FIG. 21. The cable 6 connected to one of the connectors 10 is connected to the positive electrode of the base 2a, and the cable 6 connected to the other of the connectors 10 is connected to the negative electrode of the base 2a.

In the connector 10 according to the present embodiment, the contact portion 13b formed at the terminal 13 so as to be elastically deformable in the vertical direction is brought into contact with the upper surface of the LED substrate 3, so that the contact portion 13b is made conductive with the LED substrate 3. Also, the locking portion 14c of each of the locking members 14 is locked to the lower surface of the mounting substrate 4, so that the contact portion 13b of the terminal 13 is held on the upper surface of the LED substrate 3 in a state where the contact portion 13b is in press-contact with the upper surface of the LED substrate 3. Thereby, the terminal 13 can be easily connected to the LED substrate 3 without soldering, and hence the mounting work of the connector 10 can be performed very easily.

In this case, when the connector main body 11 is inserted into the mounting hole 4a of the mounting substrate 4, the elastic piece portion 14b is elastically deformed rearward while the locking portion 14c of each of the locking members 14 is in contact with the edge portion of the mounting hole 4a, and then, when the locking portion 14c goes over the edge portion of the mounting hole 4a, the elastic piece portion 14b is restored into its original shape so that the locking portion 14c is locked to the lower surface of the mounting substrate 4. Thereby, the insertion resistance at the time when the connector main body 11 is inserted into the mounting hole 4a can be reduced by the elastic deformation of the elastic piece portion 14b, and also the locking portion 14c can be surely locked to the lower surface of the mounting substrate 4 by the restoration of the elastic piece portion 14b.

Further, the terminal housing portion 11c, in which the terminal 13 is housed from the opening portion located on the upper surface side of the LED substrate 3, is provided in the connector main body 11 so that the upper surface opening portion of the terminal housing portion 11c is covered with the upper surface cover 12 mounted to the connector main body 11. Thereby, the inside of the terminal housing portion 11c is not exposed to the upper surface of the connector main body 11, so that the light of the LED 3a can be surely reflected by the upper surface of the connector main body 11 and the upper surface cover 12. In this case, when the upper surface of the connector main body 11 and the upper surface cover 12 have a color with high reflectance, there is an advantage that, even when the upper surface side of the connector main body 11 is arranged above the upper surface of the LED substrate 3, the upper surface side of the LED substrate 3 is not darkened by the connector main body 11 and hence the lighting effect is prevented from being reduced.

Further, since the terminal 13 is provided integrally with the cable connecting portion 13c to which the cable 6 can be connected from the outside, a cable connection terminal needs not be separately provided, and hence the number of components can be reduced.

Further, the first contact portion 13e-1, which regulates the movement of the conducting wire 6a of the cable 6 in the direction opposite to the insertion direction by biting into the conducting wire 6a, is provided at the distal end corner portion of the first contact piece 13e of the terminal 13, and also the second contact portion 13f-1, which is slidably brought into surface contact with the conducting wire 6a, is provided at the distal end of the second contact piece 13f of the terminal 13. Thereby, the coming-off of the conducting wire 6a can be prevented by the first contact portion 13e-1, and the area in contact with the conducting wire 6acan be sufficiently secured by the second contact portion 13f-1. As a result, the conducting wire 6acan be surely held without deteriorating the connection reliability.

In this case, since the second contact portion 13f-1 is formed by chamfering the distal end corner portion of the second contact piece 13f, the curved-surface-shaped contact needs not be formed by bending the distal end side of the second contact piece 13f, and hence the second contact piece 13f can be easily formed in a simple shape.

Further, since the first and second contact portions 13e-1 and 13f-1 are arranged to face each other in the direction perpendicular to the insertion direction of the conducting wire 6a, the pressing force from each of the contact portions 13e-1 and 13f-1 can be applied at the same axial position of the conducting wire 6a, and hence the conducting wire 6acan be surely sandwiched between the contact portions 13e and 13f.

Further, the first and second contact pieces 13e and 13f are formed in such a manner that the both sides of the extension portion 13g of the terminal 13 are bent and raised so as to face each other. Therefore, the contact pieces 13e and 13f can be easily formed, and hence the productivity can be improved.

Note that the locking portion 14c is provided at the locking member 14 formed of a component separated from the connector main body 11 in the above-described embodiment, but a locking portion which is locked to the mounting substrate 8 may also be provided integrally with the connector main body.

Further, one surface-shaped LED 3a is mounted to the LED substrate 3 in the above-described embodiment, but a plurality of chip-type LEDs may also be mounted to the LED substrate 3.

Further, the connector 10 is connected to the LED substrate 3 of the light-bulb type lamp in the above-described embodiment, but the present invention is not limited to the case where the connector 10 is used for the light-bulb type lamp substrate. The present invention can also be applied to a connector which is connected to a substrate of another apparatus.

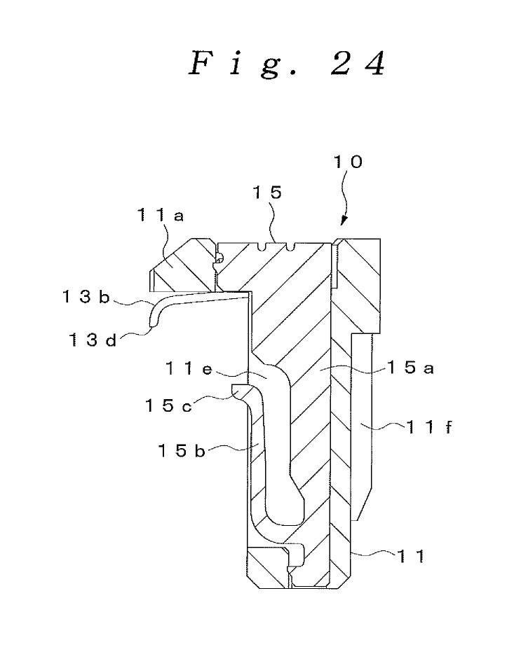

FIG. 24 to FIG. 28 show a second embodiment according to the present invention, and the same components as those in the above-described embodiment are denoted by the same reference numerals and characters.

A connector 10 of the present embodiment is attached to an LED substrate 7 and a mounting substrate 8, each of which has a thickness dimension smaller than those in the first embodiment. In place of the locking member 14 of the first embodiment, the connector 10 of the present embodiment is provided with a pair of locking members 15 corresponding to the thickness dimension each of the LED substrate 7 and the mounting substrate 8 according to the present embodiment. Note that an LED (not shown) is mounted on the upper surface of the LED substrate 7, and a mounting hole 8a and a recessed portion 8b are provided in the mounting substrate 8 similarly to the first embodiment.

Each of the locking members 15 according to the present embodiment is made of a metal plate formed by punching and is mounted to the connector main body 11. The locking member 15 is configured by a fixed piece portion 15a extending from the upper end to the lower end of the inside of a holding hole 11e, an elastic piece portion 15b extending from the fixed piece portion 15a, and a locking portion 15c provided at the distal end of the elastic piece portion 15b. The locking portion 15c is configured to be locked to the lower surface (the other surface in the thickness direction) of the mounting substrate 4. The fixed piece portion 15a is configured to be fixed to the holding hole 11e in such manner that both front and rear ends of each of the upper and lower end sides of the fixed piece portion 15a are brought into press-contact with the inner surface of the holding hole 11e. The elastic piece portion 15b is formed to extend frontward from the lower end side of the fixed piece portion 14a and is bent upward so as to extend upward from the bent portion. The locking portion 15c is formed to project frontward from the upper end of the elastic piece portion 15b, and projects frontward from the opening portion of the holding hole 11e. In this case, the upper end of the locking portion 15c is formed horizontally, and the lower end side of the locking portion 15c is formed in a shape inclined rearward and downward.

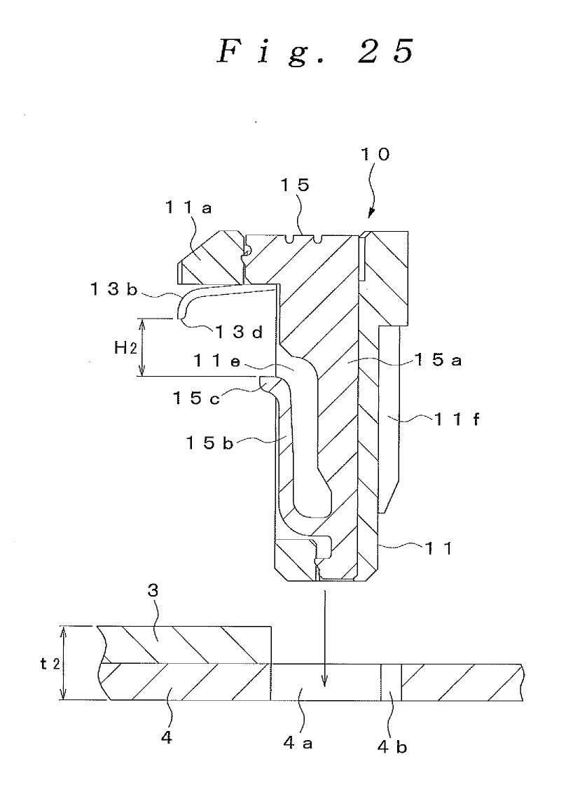

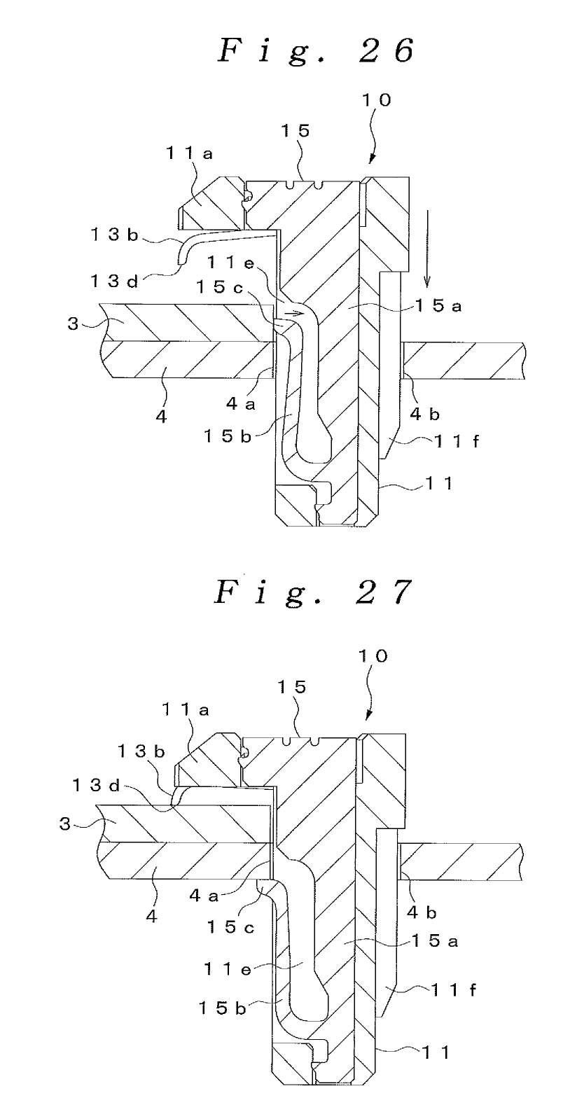

In the present embodiment, when the connector 10 is mounted to the LED substrate 7 and the mounting substrate 8, the connector main body 11 is inserted into the mounting hole 8a of the mounting substrate 8 from above the mounting substrate 8 as shown in FIG. 25. At this time, a rib 11f of the connector main body 11 is made to engage with the recessed portion 8b of the mounting hole 8a. Further, when the connector main body 11 is inserted into the mounting hole 8a, and when the locking portion 15c of each of the locking members 15 is brought into contact with the upper edge of the LED substrate 7, the elastic piece portion 15b is elastically deformed rearward by the inclination of the lower end side of the locking portion 15c, so that the locking portion 15c is displaced rearward in the holding hole 11e while being in contact with the inner surface of the mounting hole 8a as shown in FIG. 26. Then, when the locking portion 15c goes over the inner surface of the mounting hole 8a, the elastic piece portion 15b is restored to its original shape to enable the locking portion 15c to be displaced frontward, and thereby the locking portion 15c is locked to the lower surface of the mounting substrate 8 as shown in FIG. 27. Further, when the connector main body 11 is inserted into the mounting hole 8a, a contact 13d of a contact portion 13b of a terminal 13 is brought into contact with the upper surface of the LED substrate 7, and also the contact portion 13b is elastically deformed upward, so that the contact 13d is brought into press-contact with the LED substrate 7 by the restoring force of the contact portion 13b. Thereby, the contact portion 13b is made conductive with the conductive pattern (not shown) of the LED substrate 7, so that the terminal 13 is connected to the LED substrate 7. At this time, a gap H2, which is formed before the elastic deformation and which extends vertically between the contact 13d of the contact portion 13b and the locking portion 15c, is made slightly smaller than the thickness t2 of the LED substrate 7 and the mounting substrate 8. Thereby, when the locking portion 15c is locked to the lower surface of the mounting substrate 8, the contact portion 13b of the terminal 13 is brought into press-contact with the upper surface of the LED substrate 7, so that the connector main body 11 in the mounting hole 8a is held in a state where the vertical movement of the connector main body is regulated with respect to the LED substrate 7 and the mounting substrate 8. Further, the rib 11f of the connector main body 11 is engaged with the recessed portion 8b of the mounting hole 8a, and thereby the movement of the connector 10 in the width direction is regulated.

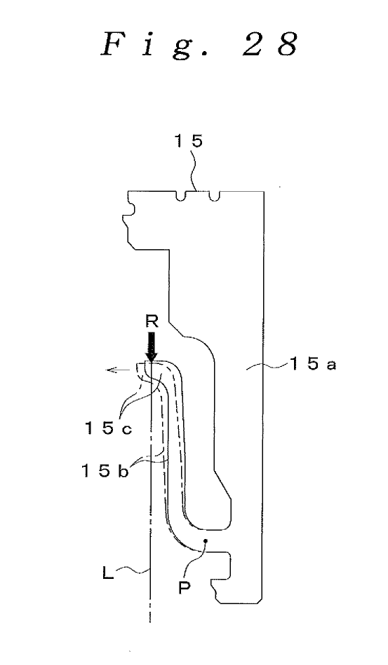

Further, in the above-described mounting state, when a force is applied to the connector main body 11 in the direction opposite to the direction of insertion into the mounting hole 8a, the locking portion 15c of the locking member 15 receives a downward counter force R from the lower surface of the mounting substrate 8 as shown in FIG. 28. At this time, the elastic piece portion 15b is elastically deformed with the lower end side bent portion as a fulcrum P. However, the fulcrum P is located on the rear side relative to an extension line L in the direction in which the counter force R is applied, and hence a counterclockwise rotation moment in FIG. 28 is generated around the fulcrum P. Thereby, the elastic piece portion 15b is elastically deformed frontward as shown by the broken-dotted line in FIG. 28, and the locking portion 15c is displaced frontward while being locked to the lower surface of the mounting substrate 8. Therefore, even when a force is applied to the connector main body 11 in the direction opposite to the insertion direction, the locking between the locking portion 15c and the mounting substrate 8 is not released.

In the present embodiment, the connector 10 is configured such that the locking member 15, in which the gap between the contact 13d of the contact portion 13b and the locking portion 15c is different from the gap in the locking member 14 of the first embodiment, can be mounted to the connector main body 11 in place of the locking member 14 of the first embodiment. Therefore, only by replacing the locking member 14 with the locking member 15, the connector 10 can be mounted to the LED substrate 7 and the mounting substrate 8 which have a thickness dimension different from that of the LED substrate 3 and mounting substrate 4 of the first embodiment, and hence the versatility of the connector 10 can be improved.

In this case, since the opening portion of the holding hole 11e of the connector main body 11 is formed to have a length substantially covering the entire vertical length of the front surface of the connector main body 11 except the extension portion 11a, even when the height position of the locking portion 15c of the locking member 15 is different from that of the locking portion 14c of the first embodiment, the locking portion 15c of the present embodiment can be arranged at the opening portion of the holding hole 11e.

Further, when a force is applied to the connector main body 11 in the direction opposite to the direction of insertion into the mounting hole 8a, the elastic piece portion 15b is elastically deformed in the direction (in the front direction) opposite to the deformation direction (in the rear direction) at the time of insertion, while the locking portion 15c is locked to the lower surface of the mounting substrate 8. Therefore, even when a force is applied to the connector main body 11 in the direction opposite to the insertion direction, the locking between the locking portion 15c and the mounting substrate 8 is not released, and hence the connector main body 11 can be surely mounted to the LED substrate 7 and the mounting substrate 8.

Note that the other configurations and effects in the present embodiment are substantially the same as those of the first embodiment.

### REFERENCE SIGNS LIST

1 . . . Light-bulb type lamp

3 . . . LED substrate

4 . . . Mounting substrate

4a . . . Mounting hole

6 . . . Cable

7 . . . LED substrate

8 . . . Mounting substrate

8a . . . Mounting hole

10 . . . Connector

11 . . . Connector main body

11c . . . Terminal housing portion

12 . . . Upper surface cover

13 . . . Terminal

13b . . . Contact portion

13c . . . Cable connecting portion

13e . . . First contact piece

13f . . . Second contact piece

13e-1 . . . First contact portion

13f-1 . . . Second contact portion

14 . . . Locking member

14b . . . Elastic piece portion

14c . . . Locking portion

15 . . . Locking member

15b . . . Elastic piece portion

15c . . . Locking portion

1. A connector including a connector main body inserted into a mounting hole provided in a plate-like mounting object, and a terminal held at the connector main body, the terminal being connected to one surface in a thickness direction of the mounting object, the connecter comprising:
a contact portion which is formed at the terminal so as to be elastically deformable in the thickness direction of the mounting object and is made conductive with the mounting object by being brought into contact with the one surface in the thickness direction of the mounting object; and
a locking member which is mounted to the connector main body and is provided with a locking portion that is locked to the other surface in the thickness direction of the mounting object to thereby hold the contact portion of the terminal in a state where the contact portion is in press-contact with the one surface in the thickness direction of the mounting object,
wherein the locking member is formed so that a gap between the contact portion and the locking portion is smaller than a thickness dimension of the mounting object,
the connector main body is held at the mounting object by the mounting object being sandwiched between the contact portion and the locking portion, and
the connector main body is formed so as to be able to mount therein a plurality of kinds of locking members respectively having different gaps between the contact portion and the locking portion.

2. The connector according to claim 1, wherein
the locking portion is provided at an elastically deformable elastic piece portion, and
when the connector main body is inserted into the mounting hole from the side of the one surface in the thickness direction of the mounting object, the elastic piece portion is elastically deformed in a predetermined direction while the locking portion is in contact with the edge portion of the mounting hole, and when the elastic piece portion goes over the edge portion of the mounting hole, the elastic piece portion is restored to the original shape of the elastic piece portion and the locking portion is locked to the other surface in the thickness direction of the mounting object.

3. The connector according to claim 2, wherein, when a force is applied to the connector main body in the direction opposite to the direction of insertion into the mounting hole, the elastic piece portion is elastically deformed in the direction opposite to the predetermined direction while the locking portion is locked to the other surface in the thickness direction of the mounting object.

4. The connector according to claim 1, further comprising:
a terminal housing portion which is provided in the connector main body and is configured to house therein the terminal from an opening portion located on the side of the one surface in the thickness direction of the mounting object; and
a cover which covers the opening portion of the terminal housing portion by being mounted to the connector main body.

5. The connector according to claim 1, wherein the terminal is provided integrally with a cable connecting portion to which a cable can be connected from an outside.

6. The connector according to claim 1, wherein the mounting object includes a substrate with a light emitting diode (LED) mounted thereto.

7. The connector according to claim 6, wherein the substrate is a substrate used for a light-bulb type lamp using an LED as a light source.
